(19) United States
(12) Patent Application Publication
(10) Pub. No.: US 2023/0015725 A1
(43) Pub. Date: Jan. 19, 2023

(54) COMBINATION LOCK AND THE METHOD FOR OPERATING THE SAME

(71) Applicant: Yao-Kun Yang, CHANGHUA COUNTY (TW)

(72) Inventor: Yao-Kun Yang, CHANGHUA COUNTY (TW)

(21) Appl. No.: 17/954,270

(22) Filed: Sep. 27, 2022

Related U.S. Application Data
(63) Continuation-in-part of application No. 16/891,089, filed on Jun. 3, 2020.
Application No. 16/891,089 is a continuation-in-part of application No. 16/100,208, filed on Aug. 10, 2018, now abandoned.

(51) Int. Cl. E05B 19/00; E05B 37/02; E05B 49/00

(52) U.S. Cl. CPC E05B 19/0005; E05B 37/025; E05B 49/00

(57) ABSTRACT

A method for operating a combination lock including a body and a shackle. A keybox is located in the body and includes a cover. The body includes a first control panel, a second control panel and a switch button. The method includes a step of setting a first combination to the first control panel, a second combination to the second control panel. A step of switching the switch button to the first position so that the shackle is operated and the cover is opened relative to the keybox by inputting the first combination or the second combination from the first control panel. When the switch button is switched to the second position, the shackle is operated and the cover is opened relative to the keybox by inputting the first combination or the second combination from the second control panel.

### CROSS-REFERENCE TO RELATED PATENT APPLICATION

This application is a Continuation-In-Part patent application of applicant's former patent application Ser. No. 16/891,089, which is a Continuation-In-Part patent application of applicant's former patent application Ser. No. 16/100,208. The entire content of the above identified application is incorporated herein by reference.

### BACKGROUND OF THE INVENTION

Some references, which may include patents, patent applications and various publications, may be cited and discussed in the description of this disclosure. The citation and/or discussion of such references is provided merely to clarify the description of the invention and is not an admission that any such reference is “prior art” to the disclosure described herein. All references cited and discussed in this specification are incorporated herein by reference in their entireties and to the same extent as if each reference was individually incorporated by reference.

### FIELDS OF THE INVENTION

The present disclosure relates to a combination lock and a method of operating the same, and more particularly to a combination lock that can be operated in multiple ways.

### DESCRIPTIONS OF RELATED ART

The conventional combination lock generally includes 3 to 4 digital wheels and each wheel has 0 to 9 digits, the correct combination requires the pre-set digit shown in each of the digit wheels. Nevertheless, the shortcomings of the conventional combination locks is that the combination of the digits can be decoded, or the users forget the combination. Besides, a surf lock is developed and provides a keybox that is used to safely keep keys in the keybox. The keybox is also controlled by a correct combination.

U.S. Pat. No. 9,540,845 and US Pub. No. 2017/0234038 respectively disclose a locking mechanism with a room for keeping keys therein. It is noted that only one combination unit or control unit is available for pivoting the cover or the door between a closed position and an opened position. That is to say, the cover or the door requires one set of combination, and/or the lock requires another set of combination. Applicant believes the disclosed method for operating the lock mechanism still has safety limitation and needs to be improved.

The present invention is intended to provide a method for operating a combination lock with a keybox, and the method is designed to eliminate the drawbacks mentioned above.

### SUMMARY OF THE INVENTION

The present invention relates to a combination lock and a method of operating the same.

In one aspect, the combination lock comprises a body, a first control panel, a second control panel and switch button; wherein the body has an accommodating room and a shackle on the top of the body, the shackle includes a first end pivotably and movably connected to the body, and a second end removably inserted into the body, the second end has an annular fasten recess. The first control panel is mounted on the body, the first control panel includes a plurality of multiple digit wheels and a driving portion; part of the multiple digit wheels is exposed on the outer surface of the body, and another part of the multiple digit wheels is located in the accommodating room; the driving portion is located in the accommodating room and is engaged with the part of the multiple digit wheels located in the accommodating space; the multiple digit wheels controls the driving portion to detachably engaging with the fasten recess of the shackle. The second control panel is mounted on the body, the second control panel includes a keypad and a controlling portion, the keypad is exposed on the outer surface of the body, and the controlling portion is located in the accommodating room and has a driving motor, a fasten hook and a microcontroller; wherein the microcontroller is electrically connected to the bottom surface of the keypad, and the driving motor and the fasten hook are disposed close to the fasten recess; the driving motor is electrically connected to the microcontroller; one end of the driving motor is engaged with one end of the fasten hook, and the other end of the fasten hook is detachably engaged with the fasten recess; wherein, the microcontroller controls the driving motor, and the driving motor controls the fasten hook to lock or unlock the fasten recess. The switch button is mounted on the body and near the shackle, the switch button includes a switch portion and a push control portion, the switch portion is exposed on the outer surface of body; one end of the push control portion is connected to the switch portion; the push control portion has a sensing unit electrically connected to the microcontroller; when switching the switch portion from a first position to a second position, the push control portion activates the sensing unit, and the sensing unit transmits a signal to the microcontroller to activate the driving motor, and the driving motor drives the fasten hook to move towards the direction of the fasten recess and engage with each other.

In another aspect, the present invention further provides another method for operating the combination lock, the method comprises:

switching step: switching the switch button of the body between the first position or the second position;

locking step: inserting the second end of the shackle into the body, the fasten recess of the second end of the shackle corresponds to and touches the driving portion of the first control panel, and the driving portion partially engages the fasten recess; and

unlocking step: rotating the multiple digit wheels to a first combination, so that the driving portion disengages with the second end of the shackle.

In certain embodiments, the switch button of the body is at the first position, the first control panel is operated, and the second control panel is not operated; wherein, the fasten hook is disengaged from the fasten recess, the sensing unit of the switch button does not contact with the push control portion, so that the driving motor is not activated.

In certain embodiments, the switch button of the body is at the second position; wherein,

the unlocking step further includes: inputting a second combination to the keypad, and the microcontroller drives the driving motor and operation of the drive motor drive the fasten hook to disengage from the fasten recess, so that the second end of the shackle is disengaged from the insertion of the body, and releases the second end of the shackle from the body; and

the locking step further includes: the sensing unit senses the insertion of the second end of the shackle and transmits a signal to the microcontroller, the microcontroller electrically controls the driving motor, the driving motor drives one end of the fasten hook to engage the fasten recess; the fasten recess engages with both the driving portion and the fasten hook then the locking operation is completed.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the front view of one combination lock of the present invention, wherein the combination lock is in locked status;

FIG. 2 shows the front view of one combination lock of the present invention, wherein the combination lock is in unlocked status;

FIG. 3 shows that the cover is opened relative to the keybox of the combination lock of the present invention;

FIG. 4 shows the first control way of the combination lock of the present invention;

FIG. 5 shows the second control way of the combination lock of the present invention;

FIG. 6 shows the third control way of the combination lock of the present invention;

FIG. 7 shows the fourth control way of the combination lock of the present invention;

FIG. 8 shows the fifth control way of the combination lock of the present invention;

FIG. 9 shows the sixth control way of the combination lock of the present invention;

FIG. 10 shows the sixth control way of the combination lock of the present invention;

FIG. 11 shows the block diagram of another embodiment of the combination lock of the present invention;

FIG. 12 shows one embodiment of the method of operating the combination lock of the present invention; and

FIG. 13 shows another embodiment of the method of operating the combination lock of the present invention.

### DETAILED DESCRIPTION OF THE PREFERRED EMBODIMENT

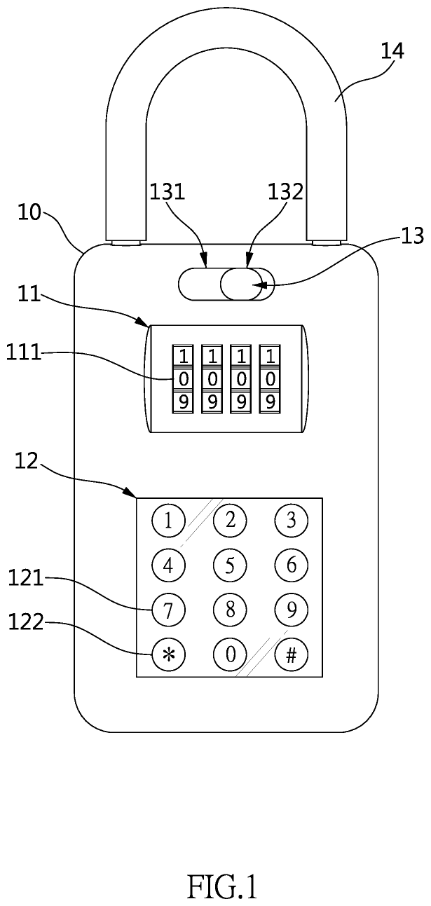

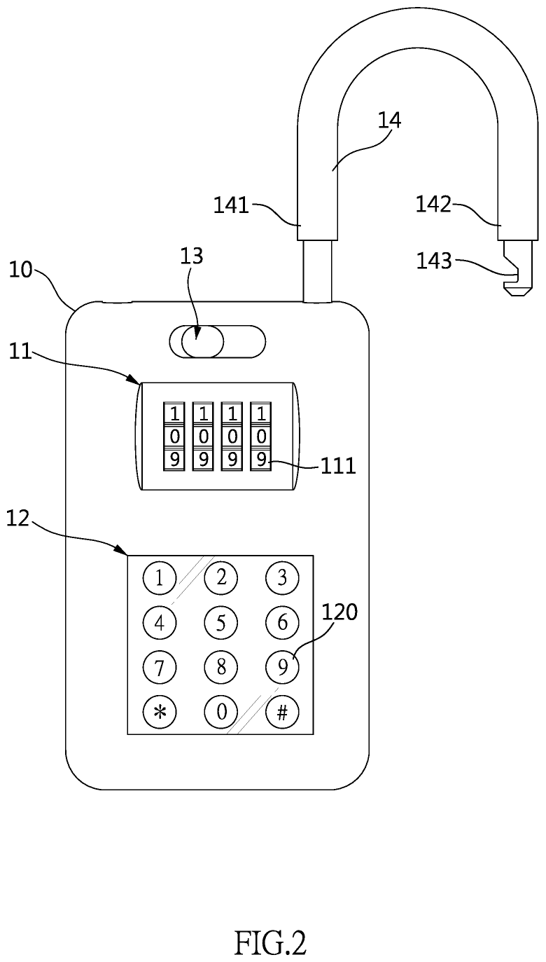

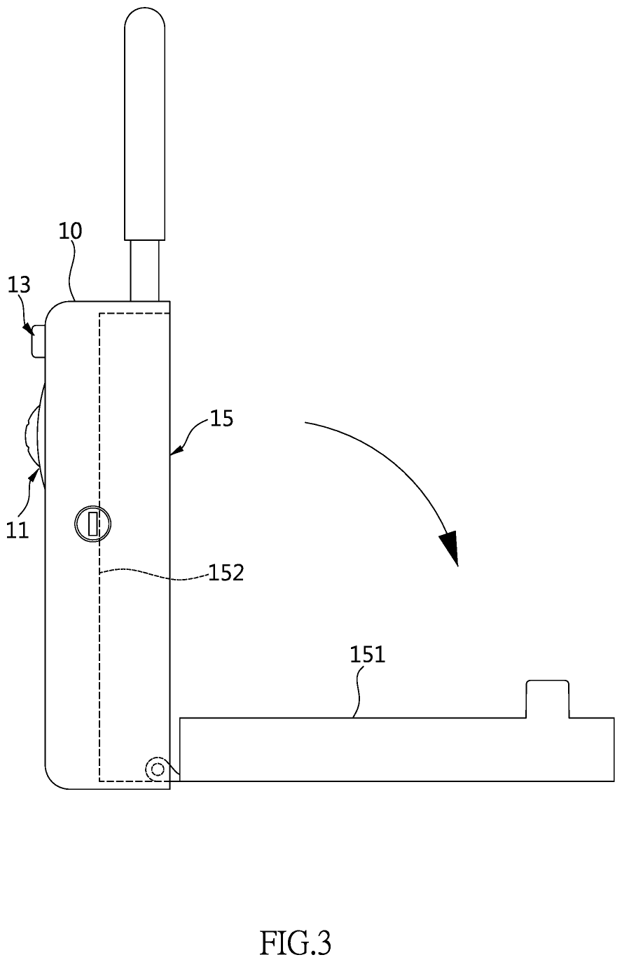

Referring to FIGS. 1 to 3, which show one embodiment of the combination lock of the present invention, the combination lock comprises a body 10 and a shackle 14, wherein the shackle 14 has the first end pivotably and movably connected to the body 10, and the second end of the shackle 14 is removably inserted into the body 10. A keybox 15 is located in the body 10 and includes a room 152 for receiving keys or the like therein. A cover 151 is pivotably connected to the body 10 and is able to close the room 152 for safety reason by any known methods.

The combination lock has a combination device connected to the body 10 and includes a first control panel 11, a second control panel 12 and a switch button 13. The first control panel 11 has multiple digit wheels 111 rotatably connected thereto. The second control panel 12 has multiple number buttons 121 and multiple function buttons 122. The number buttons 121 has 0 to 9 respectively marked thereon. The first control panel 11 and the second control panel 12 control the shackle 14 and the cover 151. The switch button 13 can be switched to a first position P1 to activate the first control panel 11, and the switch button 13 can be switched to a second position P2 to activate the second control panel 12.

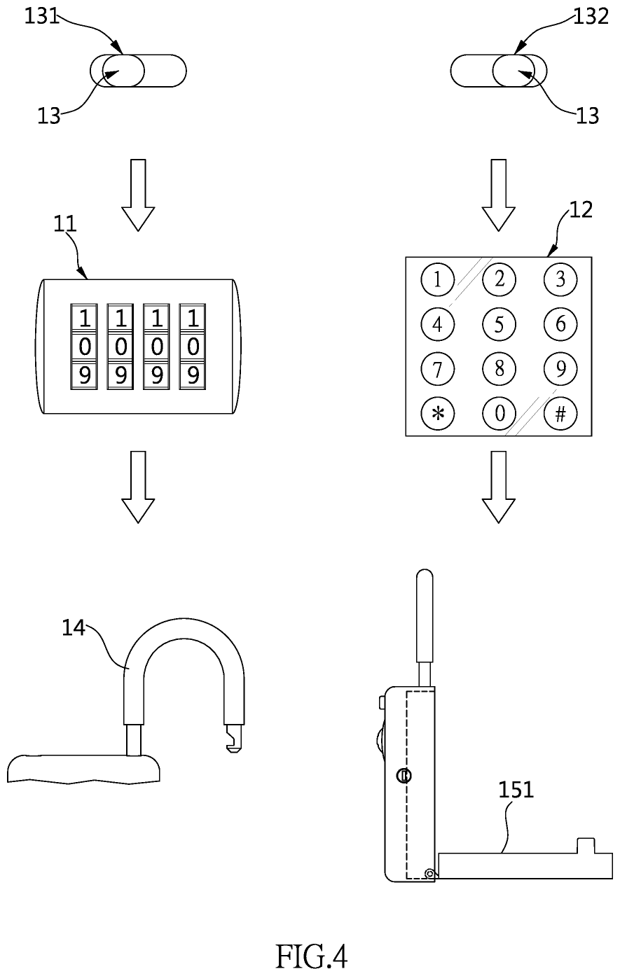

As shown in FIG. 4, the first method for operating the combination lock comprises:

a step of setting combinations: a first combination being set to the first control panel 11, a second combination being set to the second control panel 12, the second combination being a spare combination; and

a step of switching the switch button 13: when switching the switch button 13 to the first position P1, the shackle 14 is operated and the cover 151 is opened relative to the keybox 15 by inputting the first combination or the second combination from the first control panel 11, when switching the switch button 13 to the second position P2, the shackle 14 is operated and the cover 151 is opened relative to the keybox 15 by inputting the first combination or the second combination from the second control panel 12.

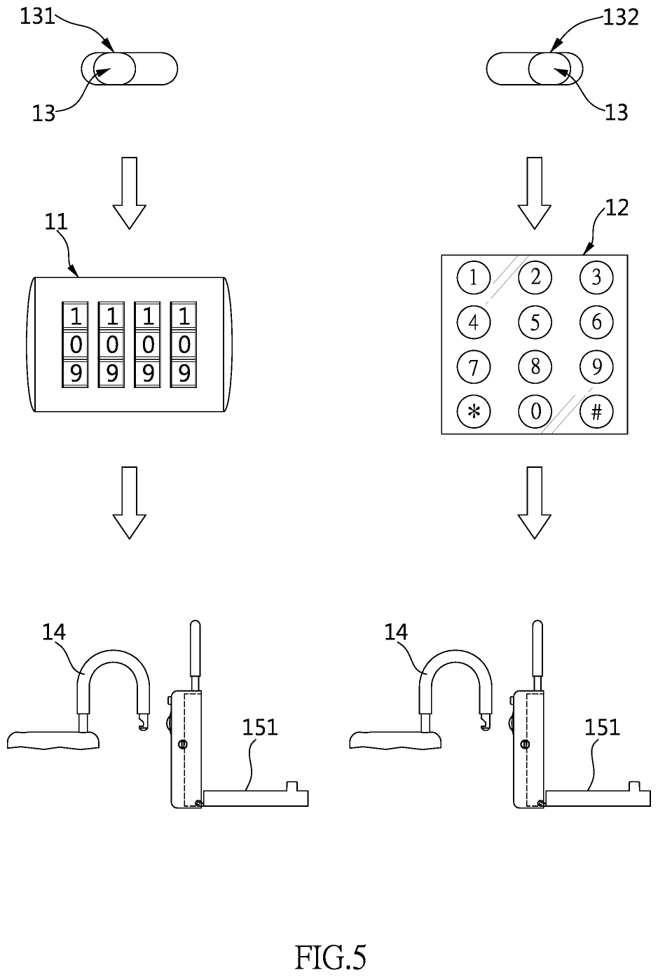

The second method is that the first control panels 11 includes a first combination, and the second control panel 12 includes a second combination. The second combination is a spare combination in case the first combination is forgotten. As shown in FIG. 5, when the switch button 13 is switched to the first position P1, the shackle 14 is operated and the cover 151 is opened relative to the keybox 15 by inputting the first combination from the first control panel 11. If the first control panel 11 is out of order or the first combination is forgotten, the switch button 13 is switched to the second position P2, the shackle 14 is operated and the cover 151 is opened relative to the keybox 15 by inputting the second combination from the second control panel 12. The first combination can be used as a primary combination and the second combination can be used as a secondary combination.

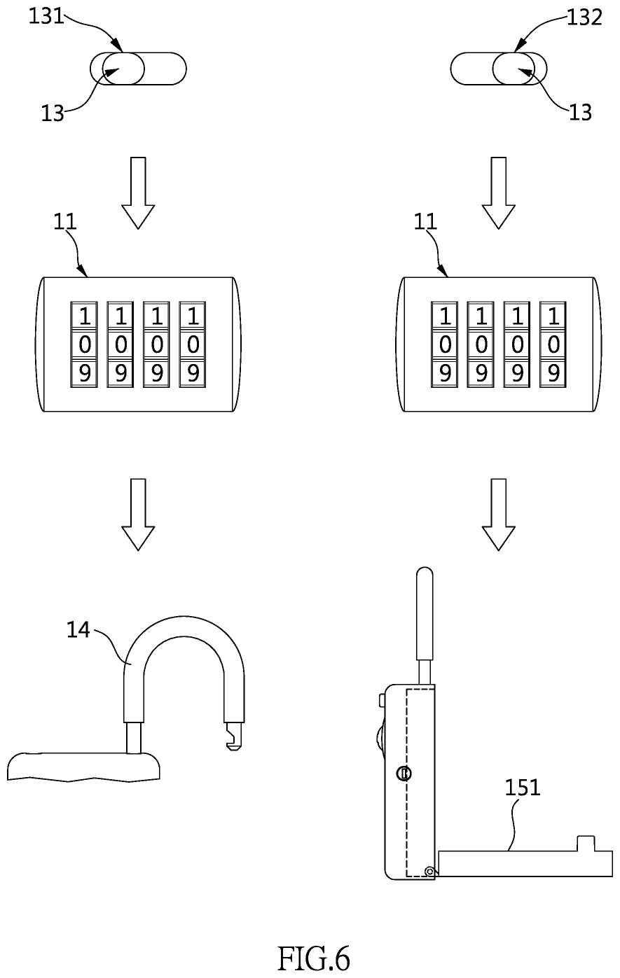

As shown in FIG. 6, the third method for operating the combination lock as described above comprises:

a step of setting combination: a first combination and a second combination being respectively set to the first control panel 11, and

a step of switching the switch button 13: when switching the switch button 13 to the first position P1, the shackle is operated by inputting the first combination from the first control panel 11, when switching the switch button 13 to the second position P2, the cover 151 is opened relative to the keybox 15 by inputting the second combination from the first control panel 11.

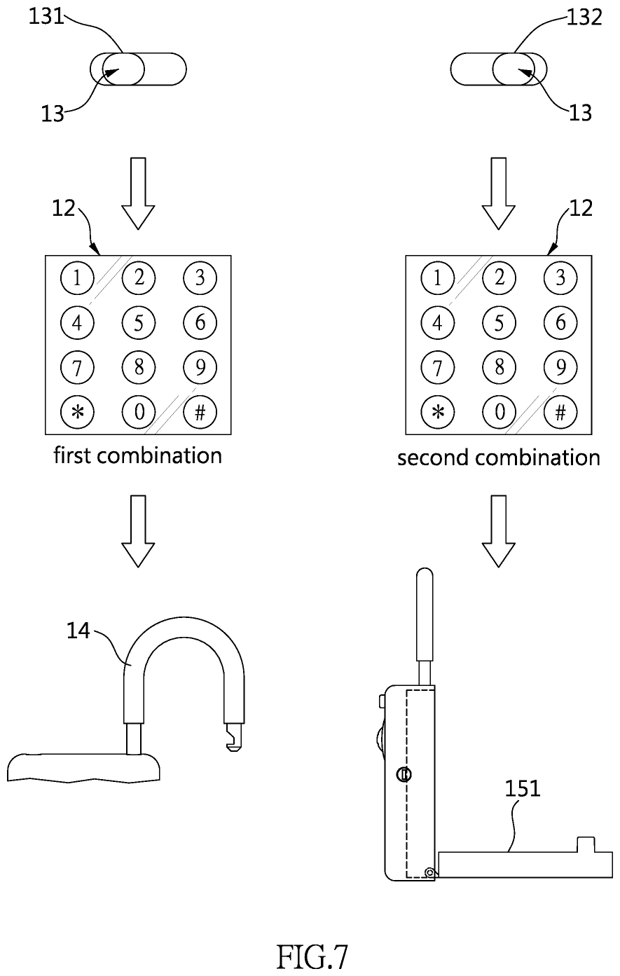

As shown in FIG. 7 which shows the fourth method, wherein the first control panel 11 in the third method can be replaced by the second control panel 12. That is to say, a first combination and a second combination are respectively set to the second control panel 12. When switching the switch button 13 to the first position P1, the shackle 14 is operated by inputting the first combination from the second control panel 12. When switching the switch button 13 to the second position P2, the cover 151 is opened relative to the keybox 15 by inputting the second combination from the second control panel 12.

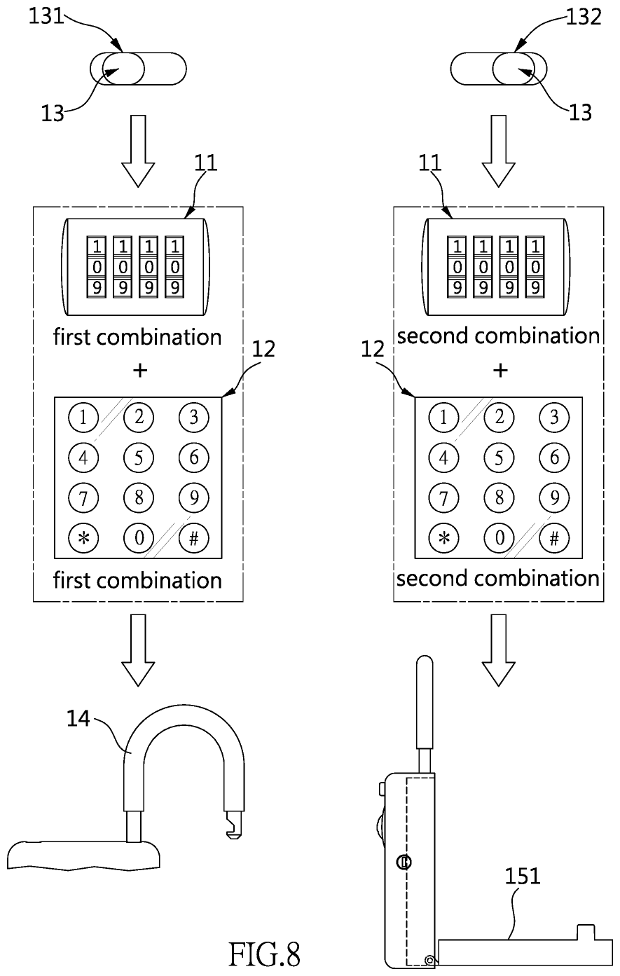

FIG. 8 shows the fifth method, wherein a first combination is set to the first control panel 11, and a second combination is set to the second control panel 12. A first combined combination is defined by a combination of the first combination and the second combination. Similarly, a third combination is further set to the first control panel 11, and a fourth combination is further set to the second control panel 12. A second combined combination is defined by a combination of the third combination and the fourth combination.

When the switch button 13 is switched to the first position P1, the shackle 14 is operated by inputting the first combined combination from the first control panel 11 and the second control panel 12 respectively. When the switch button 13 is switched to the second position P2, the cover 151 is opened relative to the keybox 15 by inputting the second combined combination from the first control panel 11 and the second control panel 12 respectively. The first combined combination may be set to control the cover 151, and the second combined combination may be set to control the shackle 14.

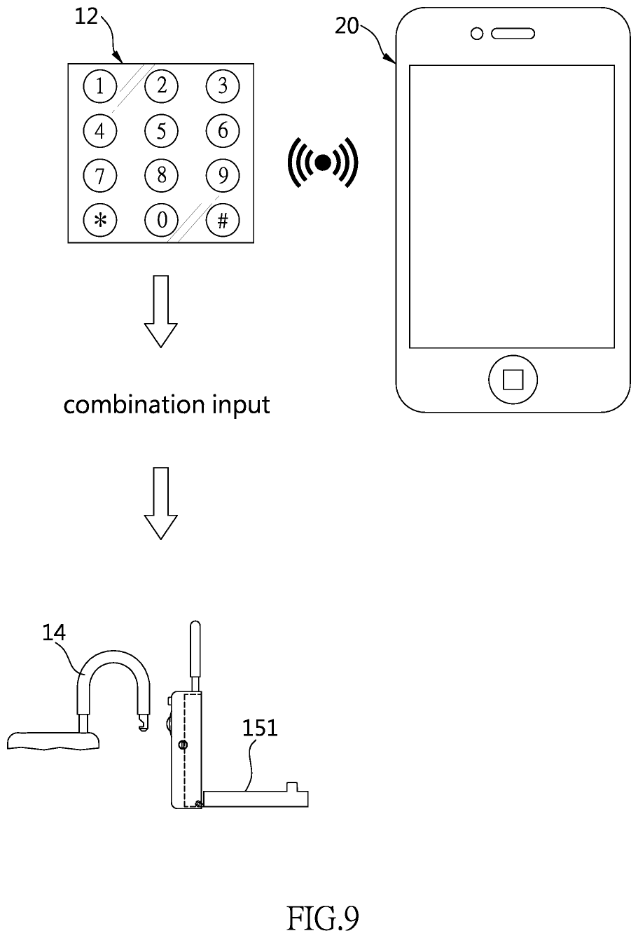

As shown in FIG. 9, the sixth method for operating the combination lock as described above comprises:

a step of connection: connecting the second control panel 12 to an application (APP) of a smart phone, and

a step of setting a combination: setting a combination to the second control panel 12 by operating the application from the smart phone, the shackle 14 being operated and/or the cover 151 being opened relative to the keybox 15 by inputting the combination to the second control panel 12.

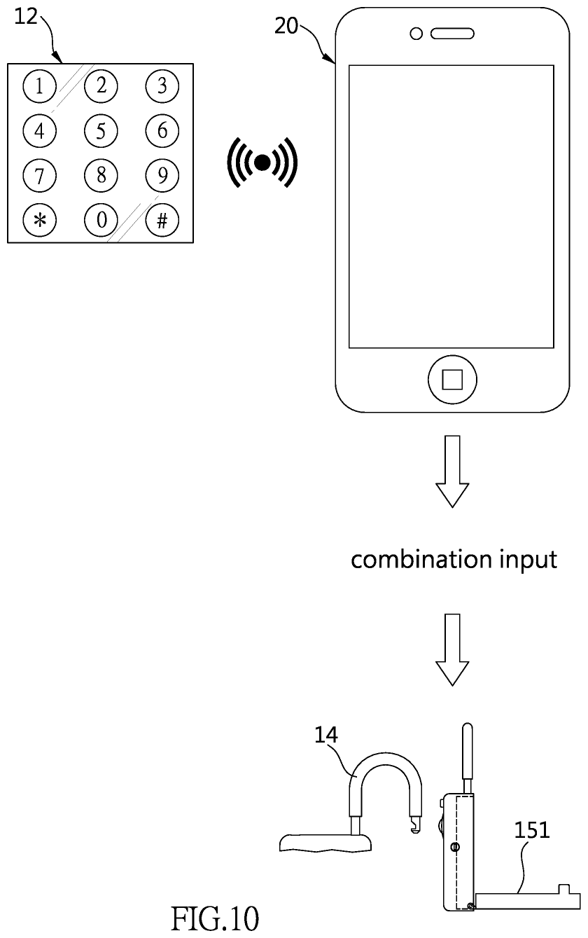

As shown in FIG. 10, the shackle 14 can also be operated and/or the cover 151 is opened relative to the keybox 15 by inputting the combination from the smart phone.

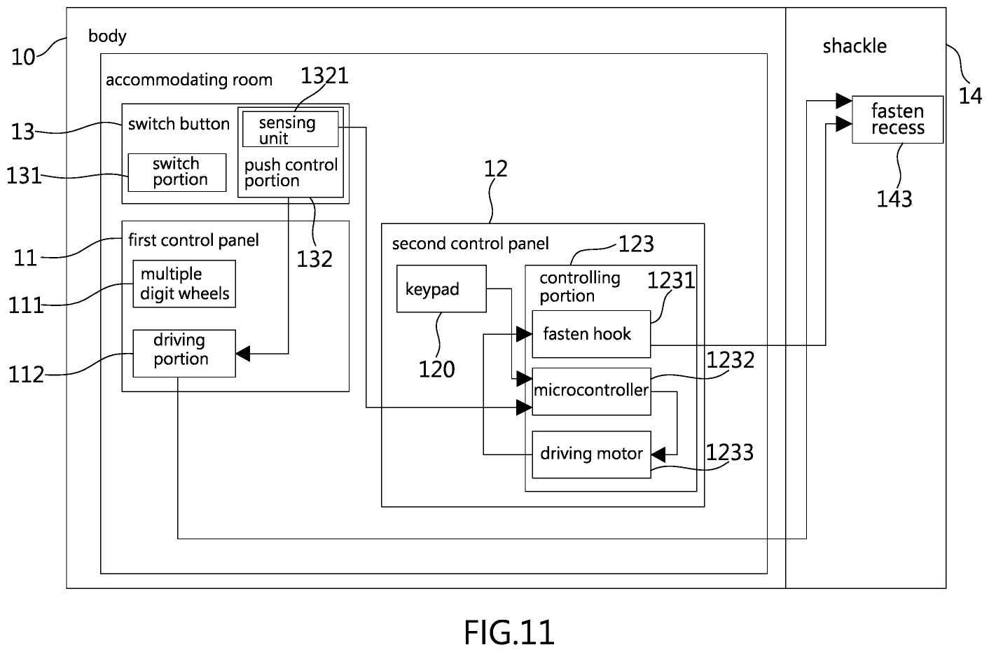

Referring to FIGS. 11, which is to be read in conjunction with FIG. 1, another embodiment of the invention provides a combination lock, including a body 10, a first control panel 11, a second control panel 12 and switch button 13.

Specifically, the body 10 includes an accommodating room and a shackle 14 on the top of the body 10, the shackle 14 includes a first end 141 pivotably and movably connected to the body 10, and a second end 142 removably inserted into the body 10, the second end 142 has an annular fasten recess 143.

The first control panel 11 is mounted on the body 10, the first control panel 11 includes multiple digit wheels 111 and a driving portion 112; part of the multiple digit wheels 111 is exposed on the outer surface of the body 10, and another part of the multiple digit wheels 111 is located in the accommodating room; the driving portion 112 is located in the accommodating room and is engaged with another part of the multiple digit wheels 111 located in the accommodating space. The multiple digit wheels 111 control the driving portion 112 to detachably engage with the fasten recess 143 of the shackle 14.

The second control panel 12 is mounted on the body 10, the second control panel 12 includes a keypad 120 and a controlling portion 123, the keypad 120 is exposed on the outer surface of the body 10, the keypad 120 has multiple number buttons 121 and multiple function buttons 122. The number buttons 121 has 0 to 9 respectively marked thereon. The controlling portion 123 is located in the accommodating room and has a driving motor 1231, a fasten hook 1232 and a microcontroller 1233. In detail, the microcontroller 1233 is electrically connected to the bottom surface of the keypad 120, and the driving motor 1231 and the fasten hook 1232 are disposed close to the fasten recess 143. The driving motor 1231 is electrically connected to the microcontroller 1233. Specifically, one end of the driving motor 1231 is engaged with one end of the fasten hook 1232, and the other end of the fasten hook 1232 is detachably engaged with the fasten recess 143. Further, the microcontroller 1233 controls the driving motor 1231, and the driving motor 1231 controls the fasten hook 1232 to lock or unlock the fasten recess 143.

Further, the switch button 13 is mounted on the body 10 and near the shackle 14. The switch button 13 includes a switch portion 131 and a push control portion 132, the switch portion 131 is exposed on the outer surface of body 10. One end of the push control portion 132 is connected to the switch portion 131. The push control portion 132 has a sensing unit 1321 electrically connected to the microcontroller 1233. The switch portion 131 can be switched between a first position P1 and a second position P2 to operate multiple ways of locking and unlocking methods. For example, the switch button 13 can be switched to a first position P1 to activate the first control panel 11, or the switch button 13 can be switched to a second position P2 to activate both the first control panel 11 and the second control panel 12.

When switching the switch portion 131 from a first position P1 to a second position P2, the push control portion 132 activates the sensing unit 1321, and the sensing unit 1321 transmits a signal to the microcontroller 1233 to activate the driving motor 1231, and the driving motor 1231 drives the fasten hook 1232 to move towards the direction of the fasten recess 143 and engage with each other.

The invention further provides a method for operating a combination lock, including:

switching step S100: switching the switch button 13 of the body 10 between the first position P1 or the second position P2;

locking step S200: inserting the second end 142 of the shackle 14 into the body 10, the fasten recess of the second end 142 of the shackle 14 corresponds to and touches the driving portion 112 of the first control panel 11, and the driving portion 112 partially engages the fasten recess 143; and

unlocking step S300: rotating the multiple digit wheels 111 to a first combination, so that the driving portion 112 disengages with the second end 142 of the shackle 14.

Further, the method for operating a combination lock includes more steps:

the locking step further includes another locking step S201: the sensing unit 1321 senses the insertion of the second end 142 of the shackle 14 and transmits a signal to the microcontroller 1233, the microcontroller 1233 electrically controls the driving motor 1231, the driving motor 1231 drives one end of the fasten hook 1232 to engage the fasten recess 143; the fasten recess 143 engages with both the driving portion 112 and the fasten hook 1232; and

the unlocking step includes another unlocking step S301: inputting a second combination to the keypad 120, and the microcontroller 1233 drives the driving motor 1231 and operation of the drive motor drive the fasten hook 1232 to disengage from the fasten recess 143, so that the second end 142 of the shackle 14 is disengaged from the insertion of the body 10.

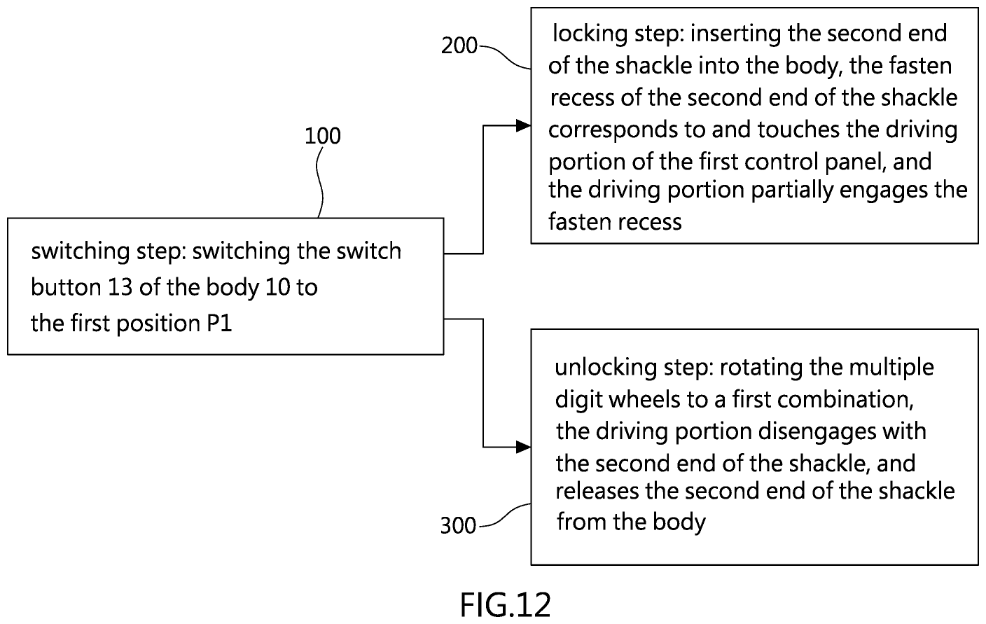

Referring to FIG. 12, which shows the embodiment of unlocking the combination lock when the switch button 13 of the body 10 is at the first position. The method includes:

switching step S100: switching the switch button 13 of the body 10 to the first position P1; and

unlocking step S300: rotating the multiple digit wheels 111 to a first combination, the driving portion 112 disengages with the second end 142 of the shackle 14, and releases the second end 142 of the shackle 14 from the body 10.

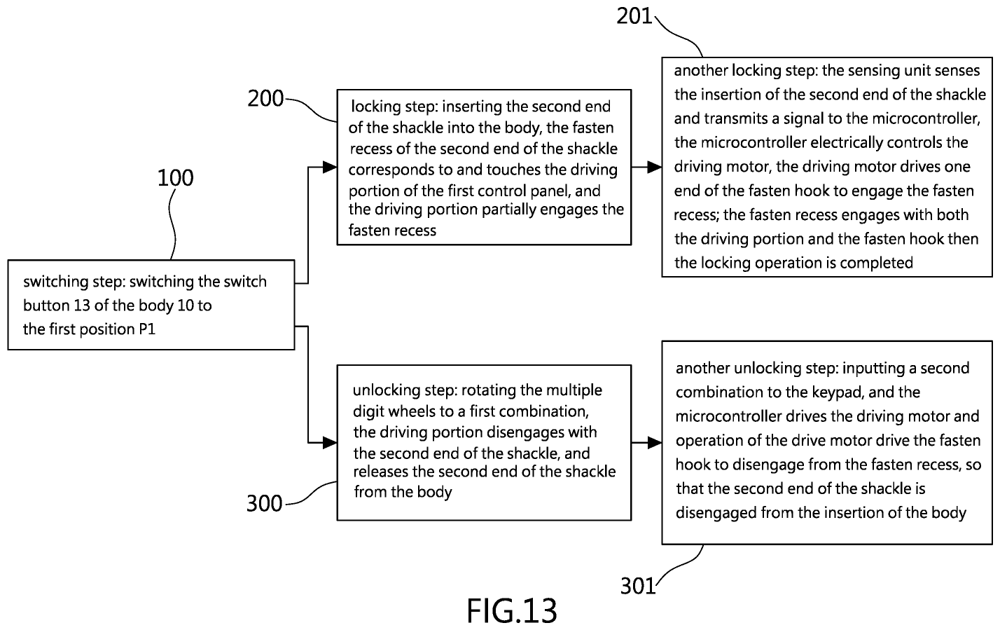

Referring to FIG. 13, which shows the embodiment of unlocking the combination lock when the switch button 13 of the body 10 is at the second position P2. The method includes:

switching step S100: switching the switch button 13 of the body 10 to the second position P2.

unlocking step S300: rotating the multiple digit wheels 111 to a first combination, the driving portion 112 disengages with the second end 142 of the shackle 14;

another locking step S301: inputting a second combination to the keypad 120, and the microcontroller 1233 drives the driving motor 1231 and operation of the drive motor drive the fasten hook 1232 to disengage from the fasten recess 143, so that the second end 142 of the shackle 14 is disengaged from the insertion of the body 10, and releases the second end 142 of the shackle 14 from the body 10.

The order of the locking steps S300 or S301 can be adjusted, that is to say, unlocking the combination lock can be operated by step S300 first and then step S301, or step S301 first and then step S300.

By the switch button 13, the first control panel 11 and the second control panel 12 can be switched. When the switch portion 131 of the switch button 13 is at the first position, the combination dials of the first control panel 11 is operated and control the driving portion 112 to engage or disengage the fasten recess 143 of the shackle 14; when the switch portion 131 of the switch button 13 is at the second position P2, the push control portion activates the sensing unit 1321, and the sensing unit 1321 transmits a signal to the microcontroller 1233 to activate the driving motor 1231, and the driving motor 1231 drives the fasten hook 1232 to move towards the direction of the fasten recess 143 and engage with each other. In other words, when the switch portion 131 is at the first position P1, only the driving portion 112 is engaged with the fasten recess 143 of the shackle 14, the lock can be released when rotating the multiple digit wheels 111 to the correct first combination. When the switch portion 131 is at the second position P2, the driving portion 112 and the fasten hook 1232 are both engaged with the fasten recess 143, the lock can be released when rotating the multiple digit wheels 111 of the first control panel 11 to the correct first combination and inputting the correct second combination to the keypad 120 of the second control panel 12.

In conclusion, the combination lock and the method of operating the same provide advantages:

Security: The combination of the first control panel 11 and the second control panel 12 can greatly improve security.

Accuracy: Through the microcontroller (MCU), the second control panel 12 can operate stably in control, and recognize the mode that is the first position P1 or the second position P2 of the switch button 13.

Diversity: The switch button 13 provides different control habits and practicalities for users. For example, users with poor memory can switch the switch button 13 to the first position P1 and use the first control panel 11 to unlock the combination lock, other users can switch the switch button 13 to the second position P2 with the double unlocking mechanism (the first control panel 11 and the second control panel 12). Moreover, if the user forgets the second combination, the user can switch to the first position P1 and use the first control panel 11 to unlock the combination lock.

While we have shown and described the embodiment in accordance with the present invention, it should be clear to those skilled in the art that further embodiments may be made without departing from the scope of the present invention.

What is claimed is:

1. A combination lock, comprising:
a body, having an accommodating room and a shackle on the top of the body, the shackle includes a first end pivotably and movably connected to the body, and a second end removably inserted into the body, the second end has an annular fasten recess;
a first control panel, mounted on the body, the first control panel includes a plurality of multiple digit wheels and a driving portion; part of the multiple digit wheels are exposed on the outer surface of the body, and another part of the multiple digit wheels is located in the accommodating room; the driving portion is located in the accommodating room and is engaged with the part of the multiple digit wheels located in the accommodating space; the multiple digit wheels controls the driving portion to detachably engaging with the fasten recess of the shackle;
a second control panel, mounted on the body, the second control panel includes a keypad and a controlling portion, the keypad is exposed on the outer surface of the body, and the controlling portion is located in the accommodating room and has a driving motor, a fasten hook and a microcontroller; wherein the microcontroller is electrically connected to the bottom surface of the keypad, and the driving motor and the fasten hook are disposed close to the fasten recess; the driving motor is electrically connected to the microcontroller; one end of the driving motor is engaged with one end of the fasten hook, and the other end of the fasten hook is detachably engaged with the fasten recess; wherein, the microcontroller controls the driving motor, and the driving motor controls the fasten hook to lock or unlock the fasten recess; and
a switch button, mounted on the body and near the shackle, the switch button includes a switch portion and a push control portion, the switch portion is exposed on the outer surface of body; one end of the push control portion is connected to the switch portion; the push control portion has a sensing unit electrically connected to the microcontroller; when switching the switch portion from a first position to a second position, the push control portion activates the sensing unit, and the sensing unit transmits a signal to the microcontroller to activate the driving motor, and the driving motor drives the fasten hook to move towards the direction of the fasten recess and engage with each other.

2. A method for operating a combination lock which includes:
a body, having an accommodating room and a shackle on the top of the body, the shackle includes a first end pivotably and movably connected to the body, and a second end removably inserted into the body, the second end has an annular fasten recess;
a first control panel, mounted on the body, the first control panel includes a plurality of multiple digit wheels and a driving portion; part of the multiple digit wheels is exposed on the outer surface of the body, and another part of the multiple digit wheels is located in the accommodating room; the driving portion is located in the accommodating room and is engaged with the part of the multiple digit wheels located in the accommodating space; the multiple digit wheels controls the driving portion to detachably engaging with the fasten recess of the shackle;
a second control panel, mounted on the body, the second control panel includes a keypad and a controlling portion, the keypad is exposed on the outer surface of the body, and the controlling portion is located in the accommodating room and has a driving motor, a fasten hook and a microcontroller; wherein the microcontroller is electrically connected to the bottom surface of the keypad, and the driving motor and the fasten hook are disposed close to the fasten recess; the driving motor is electrically connected to the microcontroller; one end of the driving motor is engaged with one end of the fasten hook, and the other end of the fasten hook is detachably engaged with the fasten recess; wherein, the microcontroller controls the driving motor, and the driving motor controls the fasten hook to lock or unlock the fasten recess; and
a switch button, mounted on the body and near the shackle, the switch button includes a switch portion and a push control portion, the switch portion is exposed on the outer surface of body; one end of the push control portion is connected to the switch portion; the push control portion has a sensing unit electrically connected to the microcontroller; when switching the switch portion from a first position to a second position, the push control portion activates the sensing unit, and the sensing unit transmits a signal to the microcontroller to activate the driving motor, and the driving motor drives the fasten hook to move towards the direction of the fasten recess and engage with each other;
the method comprises:
switching step: switching the switch button of the body between the first position or the second position;
locking step: inserting the second end of the shackle into the body, the fasten recess of the second end of the shackle corresponds to and touches the driving portion of the first control panel, and the driving portion partially engages the fasten recess, and then the locking operation is completed; and
unlocking step: rotating the multiple digit wheels to a first combination, the driving portion disengages with the second end of the shackle, and releases the second end of the shackle from the body.

3. The method for operating a combination lock according to claim 2, wherein, the switch button of the body is at the first position, the first control panel is operated, and the second control panel is not operated; wherein, the fasten hook is disengaged from the fasten recess, the sensing unit of the switch button does not contact with the push control portion, so that the driving motor is not activated.

4. The method for operating a combination lock according to claim 2, wherein, the switch button of the body is at the second position;
wherein the unlocking step further includes: inputting a second combination to the keypad, and the microcontroller drives the driving motor and operation of the drive motor drive the fasten hook to disengage from the fasten recess, so that the second end of the shackle is disengaged from the insertion of the body, and releases the second end of the shackle from the body; and
wherein the locking step further includes: the sensing unit senses the insertion of the second end of the shackle and transmits a signal to the microcontroller, the microcontroller electrically controls the driving motor, the driving motor drives one end of the fasten hook to engage the fasten recess; the fasten recess engages with both the driving portion and the fasten hook then the locking operation is completed.
